(19) United States
(12) Patent Application Publication
(10) Pub. No.: US 2012/0213893 A1
(43) Pub. Date: Aug. 23, 2012

(54) Edible Candy Candle

(76) Inventor: Carlos Dimas, Sacramento, CA (US)

(21) Appl. No.: 13/400,436

(22) Filed: Feb. 20, 2012

Related U.S. Application Data
(60) Provisional application No. 61/444,203, filed on Feb. 18, 2011.

(51) Int. Cl. A23G 3/54; F23D 3/16

(52) U.S. Cl. 426/103; 431/289; 426/89

(57) ABSTRACT

An edible candle stick comprising: a top portion, where said top portion is made of an edible material; an edible bottom portion extending downwardly from a bottom end of the top portion; and a wick extending from a top end of the top portion. In one particular embodiment the top portion may include an edible wax and the bottom portion may include a candy stick.

### CROSS REFERENCE TO OTHER APPLICATIONS

This application claims priority to U.S. Provisional Application Ser. No. 61/444,203 filed on Feb. 18, 2011.

### BACKGROUND OF THE INVENTION

1. Field of Invention

The present invention relates to an edible candle that includes two portions edible wax and candy.

2. Description of Related Art

Candles may be made of wax, tallow or other fatty material formed with a wick that is used for lighting purposes. Most candles are made of paraffin but also may be made of beeswax, soy or other plant waxes. Within the candle is an embedded wick that is lit with a match or other lighting source so that the wick burns at a pace associated with the wax that surrounds the wick.

Historically candles are used for lighting purposes. Candles are also used in various religious practices, for fragrance purposes or strictly for ambience. Candles have also been used in historical terms for timekeeping. One particular use of candles involves the traditional placement of candles on a birthday cake. Normally at least one or multiple candles may be placed on a birthday cake prior to the cake being sliced and eaten. Many of these candles may range in size and shape and traditionally the number of candles are equal to the recipient's age. Many children receive their birthday cakes with birthday candles and the typical child enjoys licking icing from the cake and/or the candles that may be placed on the cake.

The prior art includes examples of holders for candles that include an edible portion. Such as U.S. Pat. No. 230,307, which discloses a confection candleholder where the holder is made of an edible confection. Another example is disclosed in U.S. Pat. No. 3,088,302, which discusses a design of candleholders where there is a conventional candle that is mounted upon an edible lower portion that's impervious to heat. Further another example of a candleholder that includes an edible material as a base for a candle is disclosed in U.S. Patent Publication No. 2007/00721139, which discloses a candle apparatus having an edible base connected to a candle by means of a coupling device. These devices however include a conventional candle which is used in conjunction with the edible base therefore the wax portion of the candle at the top of the candle must be removed so that the child may consume the edible base of the candle.

Therefore it would be advantageous if a child could also ingest the entire candle along with the icing that may on the candle. Such a feature and item would definitely be popular with children and also comfort parents in knowing that the child could readily eat and digest the candle as opposed to being harmed by a wax or paraffin candle.

### SUMMARY OF THE INVENTION

The present invention relates to an edible candle stick comprising: a top portion, where said top portion is made of an edible material; an edible bottom portion extending downwardly from a bottom end of the top portion; and a wick extending from a top end of the top portion. In one particular embodiment the top portion may include an edible wax and the bottom portion may include a candy stick.

### BRIEF DESCRIPTION OF DRAWINGS

FIG. 1 depicts an edible birthday candle in accordance with the present invention.

### DETAILED DESCRIPTION

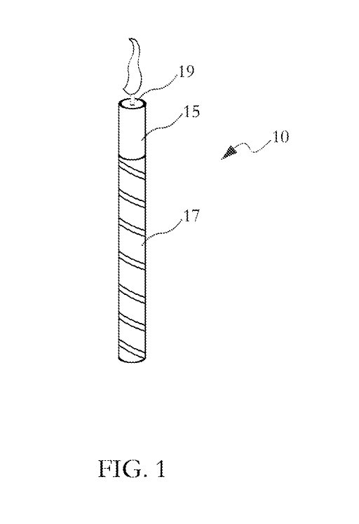

The present invention relates to an edible birthday candle that includes an edible wax portion that is combined with a candy to create a completely edible candle. In reference to FIG. 1A, an edible candle 10 is depicted. The candle 10 includes a top edible wax portion 15, which includes a wick 19. Below the wax 15 is an edible bottom portion 17, where the edible bottom may include a candy stick. This combination of edible wax 15 and the bottom portion 17 creates a completely edible birthday candle for use on a birthday cake. In one particular embodiment, the candle may measure up to 3 inches in length with a diameter of 3/16 of an inch. The entire candle is edible for consumption and the top wax portion may measure ¾ of an inch. Below the wax portion 15, the remaining 2¼ inches may comprise a porous hard candy that may be provided in various flavors.

In one particular embodiment, the bottom portion 17 includes a candy stick may be bitten into and enjoyed by children or adults. The wax 15 and bottom portion 17 may come in various flavors as stated above. These flavors can range from vanilla, chocolate, strawberry, raspberry, banana, cherry or mint to name a few exemplary flavors. Consequently, the present invention provides an edible candle for use on a birthday cake that includes the insertion of edible wax at the top of the candle, which stores the actual wick and a candy bottom portion then extends downwardly from the edible wax. The instant invention has been shown and described in what it considers to be the most practical and preferred embodiments. It is recognized, however, that departures may be made there from within the scope of the invention and that obvious modifications will occur to a person skilled in the art.

What is claimed is:

1. An edible candle stick comprising:
a. a top portion, where said top portion is made of an edible material;
b. an edible bottom portion extending downwardly from a bottom end of the top portion; and
c. a wick extending from a top end of the top portion.

2. The edible candle stick according to claim 1, where the top portion includes an edible wax.

3. The edible candle stick according to claim 1, where the bottom portion includes a candy stick.
